(19) United States
(12) Patent Application Publication
(10) Pub. No.: US 2009/0197167 A1
(43) Pub. Date: Aug. 6, 2009

(54) Fluorinated Additives For Lithium Ion Batteries

(75) Inventor: Jens Olschimke, Hannover (DE)

Correspondence Address: Solvay;c/o B. Ortego - IAM-NAFTA, 3333 Richmond Avenue, Houston, TX, 77098-3099, US

(73) Assignee: Solvay Fluor GmbH, Hannover (DE)

(21) Appl. No.: 12/089,544

(22) PCT Filed: Oct. 6, 2006
(86) PCT No.: PCT/EP2006/067129

§ 371 Date: Sep. 4, 2008

(30) Foreign Application Priority Data
Oct. 10, 2005 (DE) 10 2005 048 802.1

(51) Int. Cl. H01M 6/04; H01M 4/88

(52) U.S. Cl. 429/188; 252/182.1

(57) ABSTRACT

The usability of certain fluorinated organic compounds which have aromatic radicals, C═C double bonds, C═O groups or organosilicon groups as an additive for Li ion batteries is disclosed.

The invention relates to novel applications for certain fluorinated compounds, and to novel electrolytes, electrolyte solvents and lithium ion batteries.

Primary and secondary lithium ion batteries have great significance for mobile electronic devices. Compared to other batteries, they have features including high energy density at low weight. They comprise an anode, commonly made of carbon, a metal oxide cathode and an electrolyte composed of conductive salt and solvent. Conductive salt is typically lithium hexafluorophosphate, but it is also possible to use other salts such as lithium bis(trifluoromethanesulphonyl)imide. Some suitable compound classes of electrolyte solvents are specified, for example, in J. Electrochem. Soc. Vol. 141 (1994), pages 2989 to 2996. Frequently, alkyl carbonates or alkylene carbonates are used; see EP-A-0 643 433. Pyrocarbonates can also be used; see U.S. Pat. No. 5,427,874. Alkyl acetates, N,N-disubstituted acetamides, sulphoxides, nitriles, glycol ethers and ethers have also been recognized as useful; see EP-A-0 662 729. Often, mixtures of such solvents are used, for example also mixtures with dioxolane; see EP-A-0 385 724. For lithium bis(trifluoromethanesulphonyl)imide, 1,2-bis(trifluoroacetoxy)ethane and N,N-dimethyltrifluoroacetamide have also been used as solvents; see ITE Battery Letters Vol. 1 (1999), pages 105-109. U.S. Pat. No. 5,976,731 discloses lithium ion batteries and solvents for the conductive salt. The solvent additives used are carbazoles, phenothiazines, phenoxazines, acridines, dibenzoazepines or phenazines, which apparently stabilize the solution. Fluoromethyl methylcarbonate is also useful as a solvent or solvent additive for such batteries.

Generally, it is advisable to have a very large reservoir of useable compound classes available as a solvent or solvent additive for conductive salts in electrolytes. It is an object of the present invention to enlarge the range of useable additives for conductive salts. This object is achieved by the present invention.

The invention is based on the finding that certain fluorinated compounds are useable as additives for electrolytes and electrolyte solvents for lithium ion batteries.

The present invention provides for the use of fluorinated aromatic compounds selected from

the group of aromatic compounds consisting of 1-acetoxy-2-fluorobenzene, 1-acetoxy-3-fluorobenzene, 1-acetoxy-4-fluorobenzene, 2-acetoxy-5-fluorobenzyl acetate, 4-acetyl-2,2-difluoro-1,3-benzodioxole, 6-acetyl-2,2,3,3-tetrafluorobenzo-1,4-dioxin, 1-acetyl-3-trifluoromethyl-5-phenylpyrazole, 1-acetyl-5-trifluoromethyl-3-phenylpyrazole, allylpentafluorobenzene, benzotrifluoride, benzoyltrifluoroacetone, 1-benzoyl-3-trifluoromethyl-5-methylpyrazole, 1-benzoyl-5-trifluoromethyl-3-methylpyrazole, 1-benzoyloxy-4-(2,2,2-trifluoroethoxy)benzene, 1-benzoyl-4-trifluoromethylbenzene, 1,4-bis(t-butoxy)tetrafluorobenzene, 2,2-bis(4-methylphenyl)hexafluoropropane, bis(pentafluorophenyl)carbonate, 1,4-bis(1,1,2,2-tetrafluoroethoxy)benzene, 2,4-bis(trifluoromethyl)benzaldehyde, 2,6-bis(trifluoromethyl)benzonitrile, difluoroacetophenone, 2,2-difluorobenzodioxole, 2,2-difluoro-1,3-benzodioxole-4-carbaldehyde, 4,4′-difluorobiphenyl, 1-[4-(difluoromethoxy)phenyl]ethanone, 3-(3,5-difluorophenyl)-1-propene, trans-α,β-difluorostilbene, fluorobenzophenone, difluorobenzophenone, 1-(2′-fluoro[1,1′-biphenyl]-4-yl)propan-1-one, 6-fluoro-3,4-dihydro-2H-1-benzothiin-4-one, 4-fluorodiphenyl ether, 5-fluoro-1-indanone, 1-(3-fluoro-4-methoxyphenyl)ethanone, 4-fluoro-α-methylstyrene, fluorophenylacetonitrile, the group of compounds having an Si—C bond consisting of bis(pentafluorophenyl)dimethylsilane, 1,2-bis[difluoro(methyl)silyl]ethane, N,O-bis(trimethylsilyl)trifluoroacetamide, N-(t-butyldimethylsilyl)-N-methyltrifluoroacetamide, t-butyldimethylsilyl trifluoromethanesulphonate, 2-dimethylamino-1,3-dimethylimidazolium trimethyldifluorosiliconate, diphenyldifluorosilane, the group of compounds having a C═O bond consisting of bis(1,1,1,3,3,3-hexafluoroprop-2-yl)2-methylenesuccinate, bis(1,1,1,3,3,3-hexafluoroprop-2-yl)maleate, bis(2,2,2-trifluoroethyl)maleate, bis(perfluorooctyl)fumarate, bis(perfluoroisopropyl)ketone, 2,6-bis(2,2,2-trifluoroacetyl)cyclohexanone, butyl 2,2-difluoroacetate, cyclopropyl 4-fluorophenyl ketone, diethyl perfluoroadipate, N,N-diethyl-2,3,3,3-tetrafluoropropionamide,
the group of compounds having a C═C bond consisting of allyl 1H,1H-heptafluorobutyl ether, trans-1,2-bis(perfluorohexyl)ethylene, (E)-5,6-difluoroocta-3,7-dien-2-one,
the group of amines consisting of N,N-diethyl-1,1,2,3,3,3-hexafluoropropylamine
as an additive for electrolytes and electrolyte solvents in lithium ion batteries.

The term “difluoroacetophenone” encompasses the isomers with the fluorine substitution in the 2,3-, 2,4-, 2,5-, 2,6-, 3,4- and 3,5-position on the aromatic ring.

The term “fluorobenzophenone” encompasses in particular the isomers 2-fluorobenzophenone and 4-fluorobenzophenone.

The term “difluorobenzophenone” encompasses the isomers with the fluorine substitution in the 2,3′-, 2,3-, 2,4′-, 2,4-, 2,5-, 2,6-, 3,3′-, 3,4′-, 3,4-, 3,5- and 4,4′-position.

The term “fluorophenylacetonitrile” encompasses the isomers with the fluorine substitution in the 2-, 3- and 4-position.

The compounds can be synthesized in a known manner and are also commercially available, for example from ABCR GmbH & Co.KG, Karlsruhe, Germany.

Their amount in the electrolyte solvent is variable. The additives are preferably present in an amount of 1 to 25% by weight, based on the total weight of additive and electrolyte solvent in the additive-electrolyte solvent mixture set to 100% by weight. An amount below 1% by weight may be too low to bring about desired effects. At a content above 25% by weight, it may be possible that no further improvement is achieved or that undesired effects such as increased viscosity or the like occur.

Useful electrolyte solvents are the solvents mentioned at the outset. Particularly suitable solvents are ethylene carbonate, dimethyl carbonate, propylene carbonate and fluoromethyl methylcarbonate. Useful compounds over and above the compounds mentioned at the outset are also lactones, formamides, pyrrolidinones, oxazolidinones, nitroalkanes, N,N-substituted urethanes, sulpholanes, dialkyl sulphoxides, dialkyl sulphites, dialkyl sulphoxides and trialkyl phosphates or alkoxy esters, as mentioned, for example, in DE-A 10016816. Mention is also made there of useful conductive salts. The conductive salt is typically LiPF6 and is present in a concentration of at least 0.5 mol/l, preferably in a concentration of 0.9 to 1.1 mol/l, in the electrolyte. Other conductive salts, for example the compound Li(SO₃-i-C₃F₇)₂ described in WO03020691, are likewise useful.

Of course, it is also possible to use two or more of the additives mentioned. It is also possible to use mixtures of electrolyte solvents.

The invention further provides electrolyte solvents which comprise one or more of the abovementioned fluorinated compounds, preferably in an amount of 1 to 25% by weight, based on the mixture of additive and electrolyte solvent set to 100% by weight.

The invention also provides electrolytes which comprise the inventive electrolyte solvent and a conductive salt, preferably LiPF₆. It is present in a concentration of at least 0.5 mol/l, preferably in a concentration of 0.9 to 1.1 mol/l, in the electrolyte.

The invention further provides a lithium ion battery which comprises one or more of the additives used in accordance with the invention.

The invention combines the following advantages for lithium ion batteries: increase in the charge/discharge cycles, slower ageing of the battery, capacity increase and improvement in the charge/discharge properties.

The examples which follow are intended to further illustrate the invention without restricting its scope.

### 1.1. Mixture with 1-(benzyloxy)-4-(2,2,2-trifluoroethoxy)benzene

5 g of the compound 1-(benzyloxy)-4-(2,2,2-trifluoroethoxy)benzene (obtainable from ABCR) as an additive are mixed with 45 ml of the compound ethyl methyl carbonate (obtainable from Merck Darmstadt, Selectipur purity) and 7.6 g of LiPF₆ (obtainable from Stella Chemifa, Osaka, Japan).

### 1.2. Mixture with 2,6-bis(trifluoromethyl)benzonitrile

5 g of the compound 2,6-bis(trifluoromethyl)benzonitrile (obtainable from ABCR) as an additive are mixed with 45 ml of the compound ethyl methyl carbonate (obtainable from Merck Darmstadt, Selectipur purity) and 7.6 g of LiPF₆ (obtainable from Stella Chemifa, Osaka, Japan).

### 1.3. Mixture with 1,2-bis(difluoro(methyl)silyl)ethane

5 g of the compound 1,2-bis(difluoro(methyl)silyl)ethane (obtainable from ABCR) as an additive are mixed with 45 ml of the compound ethyl methyl carbonate (obtainable from Merck Darmstadt, Selectipur purity) and 7.6 g of LiPF₆ (obtainable from Stella Chemifa, Osaka, Japan).

### 1.4. Mixture with 4-fluorobenzophenone

5 g of the compound 4-fluorobenzophenone (obtainable from Aldrich) as an additive are mixed with 45 ml of the compound ethyl methyl carbonate (obtainable from Merck Darmstadt, Selectipur purity) and 7.6 g of LiPF₆ (obtainable from Stella Chemifa, Osaka, Japan).

### 1.5. Mixture with bis(1,1,1,3,3,3-hexafluoroprop-2-yl)maleate

5 g of the compound bis(1,1,1,3,3,3-hexafluoroprop-2-yl)maleate (obtainable from ABCR) as an additive are mixed with 45 ml of the compound ethyl methyl carbonate (obtainable from Merck Darmstadt, Selectipur purity) and 7.6 g of LiPF₆ (obtainable from Stella Chemifa, Osaka, Japan).

Mixtures which equate to the mixtures of Examples 1.1 to 1.5 can be prepared using dimethyl carbonate, diethyl carbonate, ethylene carbonate or propylene carbonate as electrolyte solvents.

1. A process for the preparation of an electrolyte solvent mixture for lithium ion batteries wherein an electrolyte solvent for lithium ion batteries is mixed with at least one additive for electrolytes and electrolyte solvents in lithium ion batteries wherein the at least one compound is selected from the group consisting of fluorinated aromatic compounds selected from the group of aromatic compounds consisting of 1-acetoxy-2-fluorobenzene, 1-acetoxy-3-fluorobenzene, 1-acetoxy-4-fluorobenzene, 2-acetoxy-5-fluorobenzyl acetate, 4-acetyl-2,2-difluoro-1,3-benzodioxole, 6-acetyl-2,2,3,3-tetrafluorobenzo-1,4-dioxin, 1-acetyl-3-trifluoromethyl-5-phenylpyrazole, 1-acetyl-5-trifluoromethyl-3-phenylpyrazole, allylpentafluorobenzene, benzotrifluoride, benzoyltrifluoroacetone, 1-benzoyl-3-trifluoromethyl-5-methylpyrazole, 1-benzoyl-5-trifluoromethyl-3-methylpyrazole, 1-benzoyloxy-4-(2,2,2-trifluoroethoxy)benzene, 1-benzoyl-4-trifluoromethylbenzene, 1,4-bis(t-butoxy)tetrafluorobenzene, 2,2-bis(4-methylphenyl)hexafluoropropane, bis(pentafluorophenyl)carbonate, 1,4-bis(1,1,2,2-tetrafluoroethoxy)benzene, 2,4-bis(trifluoromethyl)benzaldehyde, 2,6-bis(trifluoromethyl)benzonitrile, difluoroacetophenone, 2,2-difluorobenzodioxole, 2,2-difluoro-1,3-benzodioxole-4-carbaldehyde, 4,4′-difluorobiphenyl, 1-[4-(difluoromethoxy)phenyl]ethanone, 3-(3,5-difluorophenyl)-1-propene, trans-α,β-difluorostilbene, fluorobenzophenone, difluorobenzophenone, 1-(2′-fluoro[1,1′-biphenyl]-4-yl)propan-1-one, 6-fluoro-3,4-dihydro-2H-1-benzothiin-4-one, 4-fluorodiphenyl ether, 5-fluoro-1-indanone, 1-(3-fluoro-4-methoxyphenyl)ethanone, 4-fluoro-α-methylstyrene, fluorophenylacetonitrile,
the group of compounds having an Si—C bond consisting of bis(pentafluorophenyl)dimethylsilane, 1,2-b is [difluoro(methyl)silyl]ethane, N,O-bis(trimethylsilyl)trifluoroacetamide, N-(t-butyldimethylsilyl)-N-methyltrifluoroacetamide, t-butyldimethylsilyl trifluoromethane-sulphonate, 2-dimethylamino-1,3-dimethylimidazolium trimethyldifluorosiliconate, diphenyldifluorosilane,
the group of compounds having a C═O bond consisting of bis(1,1,1,3,3,3-hexafluoroprop-2-yl)2-methylenesuccinate, bis(1,1,1,3,3,3-hexafluoroprop-2-yl)maleate, bis(2,2,2-trifluoroethyl)maleate, bis(perfluorooctyl), bis(perfluoroisopropyl)ketone, 2,6-bis(2,2,2-trifluoroacetyl)cyclohexanone, butyl 2,2-difluoroacetate, cyclopropyl 4-fluorophenyl ketone, diethyl perfluoroadipate, N,N-diethyl-2,3,3,3-tetrafluoro-propionamide,
the group of compounds having a C═C bond consisting of allyl 1H,1H-heptafluorobutyl ether, trans-1,2-bis(perfluorohexyl)ethylene, (E)-5,6-difluoroocta-3,7-dien-2-one,
the group of amines consisting of N,N-diethyl-1,1,2,3,3,3-hexafluoropropylamime.

2. The process according to claim 1 wherein the additive is mixed in an amount of 1 to 25% by weight, based on the total weight of additive and electrolyte solvent.

3. An electrolyte solvent mixture for lithium ion batteries comprising a solvent for lithium ion batteries and at least one additives according to claim 1.

4. A lithium ion battery, containing an electrolyte solvent mixture prepared according to claim 1.

5. The process of claim 1 wherein the electrolyte solvent mixture additionally contains an electrolyte salt.

6. The electrolyte solvent mixture of claim 4 further comprising an electrolyte salt.
